(19) United States
(12) Patent Application Publication
(10) Pub. No.: US 2005/0240346 A1
(43) Pub. Date: Oct. 27, 2005

(54) Information transmission device

(75) Inventor: Yu-Feng Lin, Taipei City (TW)

Correspondence Address: THE LAW OFFICES OF MIKIO ISHIMARU, 1110 SUNNYVALE-SARATOGA ROAD, SUITE A1, SUNNYVALE, CA, 94087, US

(73) Assignee: Fortuna Electronic Corp., Taipei City (TW)

(21) Appl. No.: 11/090,556

(22) Filed: Mar. 25, 2005

(30) Foreign Application Priority Data
Apr. 22, 2004 (TW) 093111193

(51) Int. Cl. G01S 1/00

(52) U.S. Cl. 701/213; 342/357.06

(57) ABSTRACT

An information transmission device coupled to a GPS (Global Position System) receiver is proposed. The information transmission device is fixated to a vehicle by a base with a supporting rod, and the base is adapted for supporting a portable electrical device. The base has an opening for exposing an infrared transmitter disposed in the base. The position of the opening for exposing the infrared transmitter corresponds to the position of an infrared transceiver unit of the portable electrical device. GPS signals received by the information transmission device can be transmitted to the infrared transceiver unit of the portable electrical device by the infrared transmitter of the information transmission device, thus the portable electrical device obtains the GPS signals by means of wireless transmission.

### BACKGROUND OF THE PRESENT INVENTION

1. Field of the Present Invention

The present invention relates to an information transmission device, and more particularly, to an information transmission device utilizing infrared to transmit GPS (Global Position System) signals.

2. Description of the Related Art

Since PDAs (Personal Digital Assistant) have merits of high functionality, portability, small size and low price, PDAs are increasingly popular.

Early PDAs were basically simplified electronic notepads for users to take notes and manage their schedules. A PDA usually provides functions of a calendar, an address book and scheduling. With developments in electronics, computers and communication technology, current PDAs have added functionality to include network connectivity, much like computers that allow users to receive and transmit E-MAILs and download software from the Internet. These functionalities have led PDA to become an indispensable electronic device.

Since PDAs are portable, they may be utilized in a vehicle in conjunction with a GPS (Global Position System) to become a vehicle satellite navigation system which can provide a visual or audible representation of where the vehicle is located via the display or speaker of the PDA. As a result, the driver can know the position of the vehicle in order to reach the desired destination.

Current PDAs with GPS functionality usually provide GPS functionality through GPS receiver receiving GPS signals. Usually information is transmitted between the PDA and the GPS receiver via wireless transmission (e.g. Bluetooth) or a wired transmission.

However, not every PDA has Bluetooth functionality. In order for a PDA without functionality of Bluetooth transmission to receive GPS signals from the GPS receiver, the user can install a CF (compact flash) Bluetooth card in a CF expansion slot, if available, of the PDA to establish information transmission between the PDA and the GPS receiver. However, when a CF memory card is inserted in the CF expansion slot to increase the memory of the PDA, the CF Bluetooth card cannot be inserted simultaneously.

Alternatively, if the PDA receives the GPS signals by means of wired transmission, the casing of the PDA needs to be formed with a connecting hole that facilitates connection with the GPS receiver. However, such an arrangement affects aesthetics of the PDA. Furthermore, because the connecting line connecting the PDA and the GPS receiver is typically inserted and extracted repeatedly, the connecting terminal of the connecting line is easily damaged, which may cause a bad contact between the PDA and the GPS receiver. Additionally, the wired transmission means causes inconvenience in terms of arrangement.

Therefore, there is a need to provide a PDA that can reliably receive the GPS signals preferably in a wireless way that is convenient for the user to establish the connection between the portable electrical device and the GPS receiver.

### SUMMARY OF THE PRESENT INVENTION

In light of the drawbacks above, the primary objective of the present invention is to provide an information transmission device coupled to a GPS receiver for enabling a portable electrical device having infrared receiving and transmitting functionality to receive the GPS signal by means of wireless transmission.

Another objective of the present invention is to provide an information transmission device coupled with a GPS receiver for enabling a portable electrical device to receive the GPS signal from the GPS receiver by means of wireless transmission, eliminating abrasion problems and bad signal transmission to the portable electrical device if there is a connecting terminal connecting the portable electrical device and the GPS receiver due to repeated insertion and extraction.

A further objective of the present invention is to provide an information transmission device for enabling a portable electrical device to receive GPS signals accurately by means of infrared transmission, effectively eliminating transmitting distance and angle problems for a conventional infrared transmission, and effectively fixing the corresponding positions of the infrared transmitter and the infrared receiver.

In accordance with the above and other objectives, the present invention proposes an information transmission device coupled to a GPS receiver for enabling a portable electrical device with a infrared receiving and transmitting functionality to wirelessly receive GPS signals. The information transmission device comprises a base adapted for receiving the portable electrical device, a processing unit disposed in the base for processing the GPS signals from the GPS receiver to signals that can be read by the portable electrical device, and an infrared transmitting unit coupled to the processing unit and disposed in an opening of the base. The position of the infrared transmitting unit corresponds to the position of an infrared transceiver unit of the portable electrical device. The infrared transmitting unit of the information transmission device is adapted for transmitting the GPS signals processed by the processing unit to the infrared transceiver unit of the portable electrical device, enabling the portable electrical device to receive the GPS signals by means of wireless infrared transmission.

The information transmission device of the present invention is fixed in a vehicle by the base for enabling a user to freely use the portable electrical device in the vehicle and out of the vehicle. The information transmission device further comprises a power managing unit coupled to the processing unit, a power input port coupled to the power managing unit and a power transmitting terminal coupled to the power managing unit. Vehicle power is transmitted through the power input port via a power line to the power managing unit and is converted to a power supply suitable for charging the portable device. Thus, the vehicle power processed by the power managing unit can be provide to a power input port of the portable electrical device via the power transmitting terminal of the information transmission device. The portable electrical device may be a mobile phone, a PDA, or a palmtop computer.

Furthermore, the information transmission device of the present invention further comprises a plurality of status indicating units such as LEDs. These status indicating units are disposed on an external face of the base and coupled to the processing unit. The processing unit controls the actions of the status indicating units for indicating at least whether the reception of the GPS signal of the information transmission device is good and whether a rechargeable battery in the portable electrical device is fully charged with power provided from the vehicle power processed by the power managing unit of the information transmission device.

To provide a further understanding of the present invention, the following detailed description illustrates embodiments and examples of the present invention, this detailed description being provided only for illustration of the present invention and not as limitation of the scope of this invention.

### BRIEF DESCRIPTION OF THE DRAWINGS

The drawings included herein provide a further understanding of the present invention. A brief introduction of the drawings is as follows:

FIG. 1 is a schematic view illustrating an information transmission device according to the present invention engaging with a portable electrical device; and

FIG. 2 is a system block diagram illustrating basic internal configurations of the information transmission device and the portable electrical device of FIG. 1.

### DETAILED DESCRIPTION OF THE PREFERRED EMBODIMENTS

Reference will now be made in detail to the preferred embodiment of the present invention, the advantages and functions of the present invention being well known to those skilled in the art according to this detailed description. The present invention should therefore cover various modifications and variations made to the herein-described structure and operations of the present invention, provided they fall within the scope of the present invention.

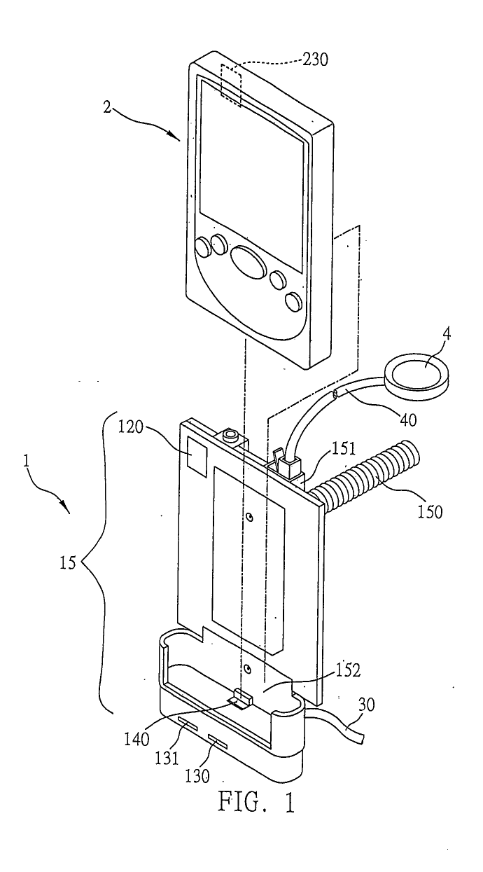

FIG. 1 is a schematic view illustrating an information transmission device 1 according to the present invention engaging with a portable electrical device 2. Referring to FIG. 1, the portable electrical device 2 may be a mobile phone, or a palmtop computer, or other electrical device in addition to a PDA of the present embodiment. The body of the information transmission device 1 is configured as a base 15 as shown in FIG. 1. A supporting rod 150 is defined on a rear side of the base 15, whereby the information transmission device 1 can be fixed inside of a vehicle (It is noted here that for simplifying the drawings and illustration, the component in the vehicle that establish the connection with the supporting rod 150 is not illustrated and drafted, and only components relevant to the present invention are illustrated; other irrelevant components such as a clipping element or a mount connecting with the supporting rod 150 are not illustrated in the drawings of the present invention).

In addition, the base 15 forms a GPS signal input port 151 on a side thereof, the GPS signal input port 151 being connected with a signal transmitting line 40 of a GPS (Global Position System) receiver 4 for enabling the information transmission device 1 to receive a GPS signal from the GPS receiver 4. Furthermore, the base 15 defines a power input port (not shown) therein, and vehicle power can be inputted to the power input port by a vehicle power line 30 to power the information transmission device 1.

The base 15 forms a receiving portion 152 for enabling the portable electrical device 2 to be installed in and removed from the receiving portion 152. The receiving portion 152 has a power transmitting terminal 140 therein for connecting with the power input port of the portable electrical device 2 when received in the receiving portion 152. In such an arrangement, vehicle power not only supply power to the information transmission device 1 and/or supply power to a rechargeable battery (not shown) in the information transmission device 1, but also can supply power to a rechargeable battery (not shown) in the portable electrical device 2.

An opening 120 is defined over the receiving portion 152 of the base 15 for exposing an infrared transmitter (not shown) disposed in the base 15. In such an arrangement, when the portable electrical device 2 is installed in the receiving portion 152, the position 230 of an infrared receiver (not shown) in a rear side of the portable electrical device 2 corresponds to the position of the opening 120; therefore, after the information transmission device 1 receives the GPS signals from the GPS receiver 4, the portable electrical device 2 installed in the receiving portion 152 of the base 15 is able to receive the GPS signals from the GPS receiver 4 by means of infrared transmission.

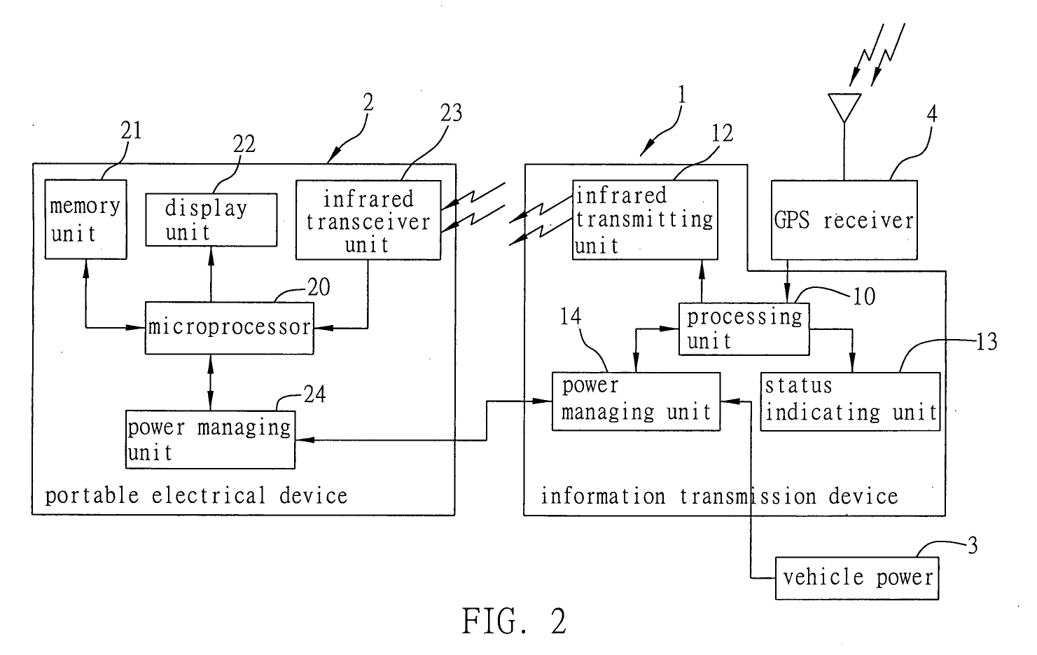

FIG. 2 is a system block diagram illustrating basic internal configurations of the information transmission device and the portable electrical device of FIG. 1. Referring to FIG. 2, the information transmission device 1 includes a processing unit 10 such as a microprocessor, an infrared transmitting unit 12, a status indicating unit 13, and a power managing unit 14. The portable electrical device 2 includes a microprocessor 20, a memory unit 21, a display unit 22, an infrared transceiver unit 23, and a power managing unit 24. It is noted that the information transmission device 1 and the portable electrical device 2 of the present invention include other function modules, but only the relevant portions related to the present invention are illustrated here.

According to the portable electrical device 2, the memory unit 21 may be any memory which the microprocessor 20 can directly access, such as a ROM (Read Only Memory), a RAM (Random Access Memory), or an EEPROM (Electrically Erasable Programmable Read Only Memory) etc. In this embodiment, the memory unit 21 is used for pre-storing a satellite navigation map program (not shown). By utilizing the satellite navigation map program and the GPS signals sent from the information transmission device 1, the portable electrical device 2 is able to provide a positioning function.

The display unit 22 such as a LCD display, is able to display a corresponding signal after the microprocessor 20 reads the stored program or information from the memory unit 21.

The power managing unit 24 is adapted to provide operating power for the portable electrical device 2 by receiving external power supply to function as a power supply to charge the battery (not shown) of the portable electrical device 2. It is noted here that the external power supply usually comprises an electric supply from a transformer (not shown) or a vehicle power received by the information transmission device 1. In the case providing power from the transformer, it converts in advance the electric supply into operating power suitable for the portable electrical device 2. Similarly, in the case of providing power from the vehicle power, the information transmission device 1 converts vehicle power 3 into operating power suitable for the portable electrical device 2 by the power managing unit 14, i.e. the power managing unit 14 of the information transmission device 1 functions as a transformer.

The infrared transceiver unit 23 is adapted for wirelessly receiving external infrared signals and for transmitting the infrared signals to the microprocessor 20 to be processed. For example, the microprocessor 20 converts the received signals into special signals and stores them in the memory unit 21 for subsequent access, or the microprocessor 20 converts the received signals into special signals and displays them via the display unit 22.

The information transmission device 1 can receive satellite signals from a satellite transmitter (not shown) using the GPS receiver 4, and then the satellite signals can be converted by the processing unit 10 of the information transmission device 1 into signals that can be read by the portable electrical device 2.

The processing unit 10 of the information transmission device 1 controls the actions of the status indicating unit 13 electrically coupled with the processing unit 10. One or more status indicating unit 13, such as LEDs (Light-Emitting Diodes) are disposed on a lower portion of the base 15, such as LEDs 130 and 131 shown in FIG. 1. According to this embodiment, the action of the LED 130 indicates whether the status of GPS signal reception of the information transmission device 1 is good. The action of LED 131 indicates whether the battery of the portable electrical device 2 is fully charged by the vehicle power received and processed by the power management unit 14.

The infrared transmitting unit 12 of the information transmission device 1 is electrically coupled to the processing unit 10, and, after the processing unit 10 processes the GPS signals from the GPS receiver 4, the processing unit 10 can transmit the processed signal to the infrared transceiver unit 23 of the portable electrical device 2 seated in the receiving portion 152 of the base 15 via the infrared transmitter (not shown) coupled to the infrared transmitting unit 12 by means of wireless transmission.

Accordingly, the portable electrical device 2 is able to receive the GPS signals via the information transmission device 1 of the present invention by wireless means of infrared transmission. In addition to eliminating the problem that a conventional portable electrical device can not effectively receive the GPS signal due to damage to the wired connection means, the infrared transmitter of the information transmission device 1 disposed in the opening 120 above the receiving portion 152 of the base 15 and optically coupled with the infrared transceiver unit 23 of the portable electrical device 2 corresponding to the infrared transmitting unit 12 of the information transmission device 1 eliminates the distance and angle issues associated with the infrared transmission.

It is to be understood that this detailed description is provided only for illustration of the present invention and not to limit the scope of this invention. For example, the position of the opening 120 disposed in the base may not only be located above the receiving portion 152 as long as its position corresponds to the position 230 of the infrared receiver electrically coupled to the infrared transceiver unit 23 of the portable electrical device 2. The present invention should therefore cover various modifications and variations made to the herein-described structures and operations of the present invention, provided they fall within the scope of the present invention as defined in the following appended claims.

1. An information transmission device coupled to a GPS (Global Positioning System) receiver for transmitting a GPS signal to a portable electrical device including an infrared transceiver unit by means of wireless transmission, the information transmission device comprising:
a base for receiving the portable electrical device;
an infrared transmitting unit disposed in the base and in communication with the corresponding infrared transceiver unit of the portable electrical device; and
a processing unit provided in the base and coupled to the infrared transmitting unit for processing the GPS signal received from the GPS receiver and outputting the signal via the infrared transmitting unit.

2. The information transmission device of claim 1, wherein the base includes a fixing unit for fixing the information transmission device in a vehicle.

3. The information transmission device of claim 2, wherein the fixed unit is a supporting rod.

4. The information transmission device of claim 1, wherein the base has a receiving portion for receiving the portable electrical device.

5. The information transmission device of claim 4, wherein a surface of the receiving portion has an opening for receiving the infrared transmitting unit.

6. The information transmission device of claim 5, wherein the position of the opening corresponds to the infrared transceiver unit of the portable electrical device.

7. The information transmission device of claim 1, further comprising at least one status indicating unit disposed on an external face of the base and coupled to the processing unit, wherein the processing unit controls the action of the at least one status indicating unit to indicate the status of the GPS signal reception of the information transmission device.

8. The information transmission device of claim 1, wherein the base further comprises a power managing unit electrically coupled to the processing unit and a power input port electrically coupled to the power managing unit enabling the information transmission device to connect with an external power source.

9. The information transmission device of claim 8, wherein the base further comprises a power transmitting terminal electrically coupled to the processing unit to supply power to the portable electrical device.

10. The information transmission device of claim 9, wherein the base further comprises a plurality of status indicating units provided on an external face of the base and coupled to the processing unit, the processing unit controlling the actions of the status indicating units to indicate a status of the GPS signal reception of the information transmission device and a power supply status of the portable electrical device.

11. The information transmission device of claim 1, wherein the portable electrical device is one of a mobile phone, a PDA (Personal Digital Assistance), or a palmtop computer.

12. The information transmission device of claim 1, wherein the processing unit is a microprocessor.
